(19) United States
(12) Patent Application Publication
(10) Pub. No.: US 2005/0012708 A1
(43) Pub. Date: Jan. 20, 2005

(54) Electrophoretic display and a method of driving said display

(76) Inventor: Hong-Da Liu, Chupei City (TW)

Correspondence Address: Troxell Law Office PLLC, Suite 1404, 5205 Leesburg Pike, Falls Church, VA, 22041, US

(21) Appl. No.: 10/618,753

(22) Filed: Jul. 15, 2003

(51) Int. Cl. G09G 3/34

(52) U.S. Cl. 345/107

(57) ABSTRACT

An electrophoretic display (EPD) has two opposite substrates with electrodes, multiple colored charged particles in the fluid, reflective areas and transmissive areas defined on one of the two substrates or respectively on the two substrates. When a positive or negative electric potential is applied to the electrodes on the opposite substrates, the colored charged particles are collected to the reflective areas or the transmissive areas. Therefore, front light radiated to the first substrate can be controlled to reflect by the reflective areas and backlight radiated to the second substrate can be controlled to pass through the two opposite substrates. Thus, the EPD in accordance with the present invention can be operated in the reflective or direct-viewing display mode or both of the reflective and direct-viewing display mode.

### BACKGROUND OF THE INVENTION

1. Field of the Invention

The present invention relates to an electrophoretic display and a method of driving said display, and more specifically to a method of selectively driving an electrophoretic display in a reflective mode or a direct-viewing display mode.

2. Description of Related Art

E-books have been developed recently, and many people prefer e-books to traditional books. An e-book uses a plane display screen to display digitally generated text so a person can read the e-book. The e-book has lots of advantages over conventional books, but the e-book has not been universally accepted. One reason the e-book has not been universally accepted is power-consumption. The plane display screen needs power to display text. When the power is turned off, the text disappears from the screen. Furthermore, a person must learn how to use the e-book. A method of conserving power while extending the persistence of the text on the screen is needed.

The power-consumption problem has been solved, and most people already know how to read an e-book, PDA, etc. The power-consumption problem was solved with the development of e-paper. E-paper is a reflective electrophoretic display material.

A company named E Ink developed a specific display material for the reflective electrophoretic display with embedded electronic ink. The electronic ink's principal components are millions of tiny microcapsules, about the diameter of a human hair. With reference to FIG. 17A, each microcapsule (70) comprises multiple positively charged white particles (71) and multiple negatively charged black particles (72) suspended in a clear fluid (73). The microcapsule (70) has a top (not numbered) and a bottom (not numbered). When a voltage is applied to a microcapsule (70) with a negative potential applied to the top of the microcapsule (70) and a positive potential applied to the bottom of the microcapsule (70), the positively charged white particles (71) move to the top of the microcapsule (70), and the negatively charged black particles (72) move to the bottom of the microcapsule (70). The positively charged white particles (71) at the top are visible to a person and block the negatively charged black particles (72). That is, the top of the microcapsule (70) appears white, and the negatively charged black particles (72) are hidden. With reference to FIG. 17B, reversing the polarity of the voltage applied to the microcapsule (70) causes the negatively charged black particles (72) to move to the top of the microcapsule (70) and the positively charged white particles (71) to move to the bottom and make the microcapsule (70) appear dark. The E Ink claims that their e-paper can be read under direct sunlight and has advantages of high contrast, low power, wide field of vision, etc.

The Xerox company has also proposed a display principle similar to E Ink's. With reference to FIG. 18A, multiple rollers (81) are mounted on a single electrode plate (80). Each roller (81) has a black hemisphere (not numbered) and a white hemisphere (not numbered). The black hemisphere has a positive electric charge (+), and the white hemisphere has a negative electric charge (−). When a negative electric potential is applied to the electrode plate (81), the black hemispheres of the rollers (81) face the electrode plate (80). On the other hand, when a positive electric potential is applied to the electrode plate (80), the white hemispheres of the rollers (81) face the electrode plate (80), as shown in FIG. 18B.

With reference to FIG. 19, the IBM company has developed an electrophoretic display also composed of two electrode plates (91, 92), a colored fluid (90) between the two electrode plates (91, 92) and multiple colored charged particles (93) suspended in the colored fluid (90). The operation of the electrophoretic display is similar to the forgoing descriptions and is not further described.

The examples of electrophoretic displays described have the following common features.

1. All the displays are reflective and display text by reflecting light in the environment.

2. Low power.

3. High contrast.

4. Clear image.

The forgoing features of e-paper are advantages, but the e-paper display cannot display clear text or images when the reflective display is used in an environment with weak light.

The present invention provides an electrophoretic display that has reflective or direct-viewing display mode to mitigate or obviate the aforementioned problems of the conventional methods.

### SUMMARY OF THE INVENTION

An objective of the present invention is to provide an electrophoretic display that can selectively be a reflective display, a direct-viewing display or a combination reflective and direct-viewing display.

Other objectives, advantages and novel features of the invention will become more apparent from the following detailed description when taken in conjunction with the accompanying drawings.

### BRIEF DESCRIPTION OF THE DRAWINGS

FIG. 1 is a side plan view in partial section of a first embodiment of an electrophoretic display pixel in accordance with the present invention;

FIGS. 2 is a top plan view of a first embodiment of transparent electrodes of the electrophoretic display in accordance with the present invention;

FIG. 3 is a top plan view of a second embodiment of the transparent electrodes of the electrophoretic display in accordance with the present invention;

FIG. 4 is a top plan view of a third embodiment of the transparent electrodes of the electrophoretic display in accordance with the present invention;

FIG. 5 is a side plan view of a first embodiment of a colored particle for the electrophoretic display in accordance with the present invention;

FIG. 6 is a side plan view of a second embodiment of the colored particle for the electrophoretic display in accordance with the present invention;

FIG. 7 is an operational side plan view in partial section of the electrophoretic display in FIG. 1 displaying a single black color;

FIG. 8 is an operational side plan view in partial section of the electrophoretic display in FIG. 1 displaying a single white color;

FIG. 9 is an operational side plan view in partial section of the electrophoretic display in FIG. 1 displaying light and black colors;

FIG. 10 is a side plan view in partial section of the electrophoretic display in FIG. 1 with a backlit module in accordance with the present invention;

FIG. 11 is a side plan view in partial section in partial section of a second embodiment of the electrophoretic display in accordance with the present invention;

FIG. 12 is an operational side plan view in partial section of the second embodiment of the electrophoretic display in FIG. 11;

FIG. 13 is a side plan view in partial section of a third embodiment of the electrophoretic display in accordance with the present invention;

FIG. 14 is a top plan view of a fourth embodiment of the transparent electrodes with a reflective layer in accordance with the present invention;

FIG. 15 is an operational side plan view of the electrophoretic display in FIG. 13;

FIG. 16A is a cross sectional side plan view of the reflective layer of the electrophoretic display in accordance with the present invention;

FIG. 16B is a side plan view of a fifth embodiment of the transparent electrodes with a reflective layer in accordance with the present invention;

FIG. 16C is a top plan view of a sixth embodiment of the transparent electrodes with the reflective layer in accordance with the present invention;

FIG. 16D is a top plan view of a seventh embodiment of the transparent electrodes with the reflective layer in accordance with the present invention;

FIG. 17A is a side plan view of a first conventional electrophoretic display in accordance with the prior art;

FIG. 17B an operational view of the first conventional electrophoretic display of FIG. 17A;

FIG. 18A is a side plan view of a second conventional electrophoretic display in accordance with the prior art;

FIG. 18B is an operational view of the second conventional electrophoretic display of FIG. 18A; and

FIG. 19 is a side plan view of a third conventional electrophoretic display in accordance with the prior art.

### DETAILED DESCRIPTION OF THE PREFERRED EMBODIMENT

An electrophoretic display (EPD) in accordance with the present invention has a reflective and direct-viewing display mode or a direct-viewing display mode. The EPD has multiple positively and/or negatively charged colored particles, two substrates each having multiple electrodes, wherein reflective and transmissive areas could be all defined on one of the two substrates or respectively on the two substrates. When applying opposite polarity of the voltage to at least two electrodes on the substrates, the charged colored particles are moved to the reflective areas or transmissive areas. That is, the charged color particles on the reflective areas or transmissive areas can be controlled whether the front light is reflected by the reflective area or not, or whether the backlight passes through the EPD or not. Therefore, by controlling the applied polarity of voltage, the EPD can be operated in a reflective display mode if the surrounding light is sufficient, or in a direct-viewing display mode when the surrounding is dim.

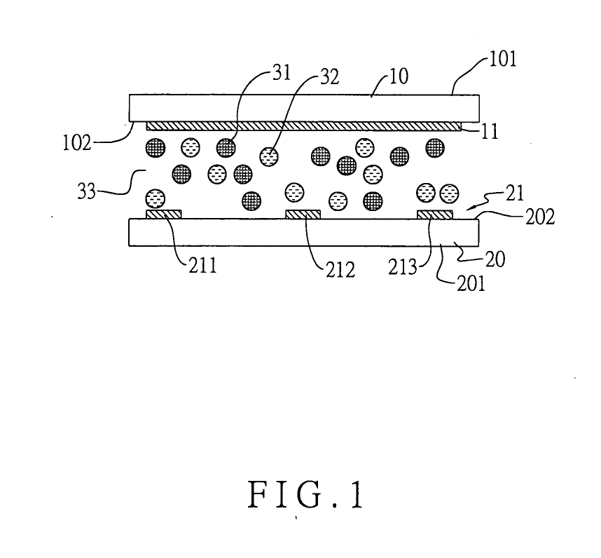

With reference to FIG. 1, each pixel of a first embodiment of the EPD in accordance with the present invention includes a first substrate (10), a second substrate (20), colored charged particles (31, 32) and fluid (33). The fluid (33) between the first and second substrates (10, 20) can be transparent or colored. The colored charged particles has dark and white colored charged particles (31, 32) that are suspended in the fluid (33).

The first substrate (10) can be made of a transparent material such as glass or plastic etc. In this preferred embodiment, the first substrate (10) has an outer face (101) and an inner face (102). The outer face (101) to which the front light from the front light module (not shown) passes through is a front face of the EDP for displaying images or text etc. The front light module can be mounted on the front face. A first transparent electrode (11) is printed on the inner face (102) and has at least one first transparent electrode layer (11). The first transparent electrode layer (11) can be defined as the reflective area by collecting enough dark or white colored particles (31, 32).

The second substrate (20) can be made of a transparent or opaque material such as glass, plastic and stainless steel etc. In this preferred embodiment, the second substrate (20) is transparent and parallel with the first substrate (10). The second substrate (20) has an inner face (202) and an outer face (201) defined as a rear face of the EDP. The inner face (202) is faced to the inner face (102) of the first substrate (10). The second transparent electrode (21) has at least two. second transparent electrode layers (211, 212, 213). In this preferred embodiment, three second transparent electrode layers (211, 212, 213) are printed on inner face (202) of one pixel of the second substrate (20) and two transmissive areas each is defined between the two second transparent electrode layers (211, 212, 213).

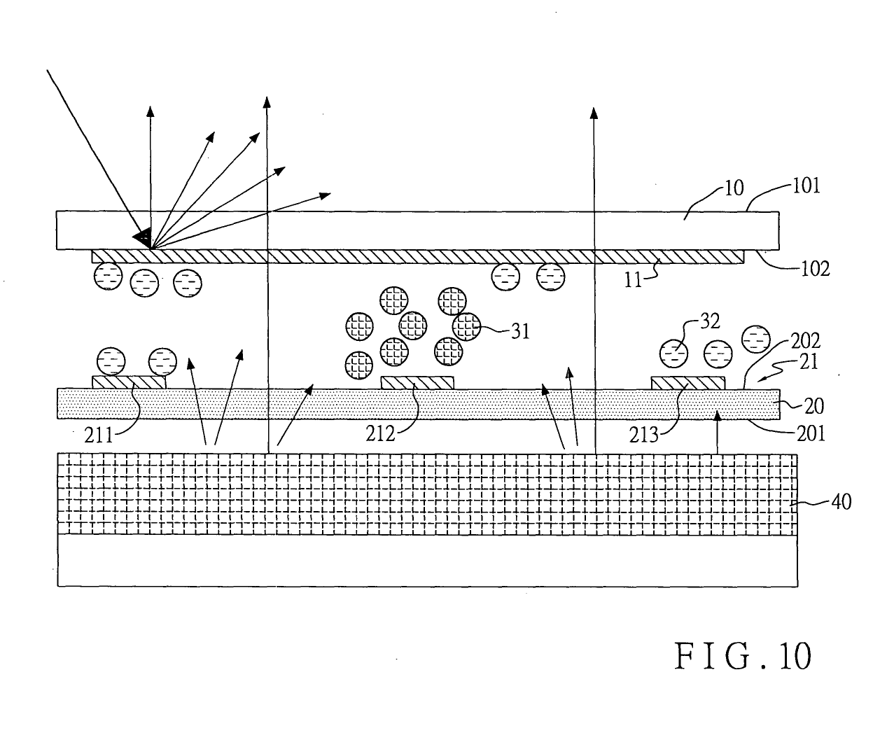

To increase brightness of the EDP in the direct-viewing display mode, with further reference to FIG. 10, a backlit module (40) is adapted to mount to the rear face (201) of the EPD. The backlight radiated from the backlit module (40) can pass through the transmissive areas to the front face (101). The backlit module (40) can be an EL (electro luminescent), PLED (polymeric light emitting diode) or OLED (organic light emitting diode).

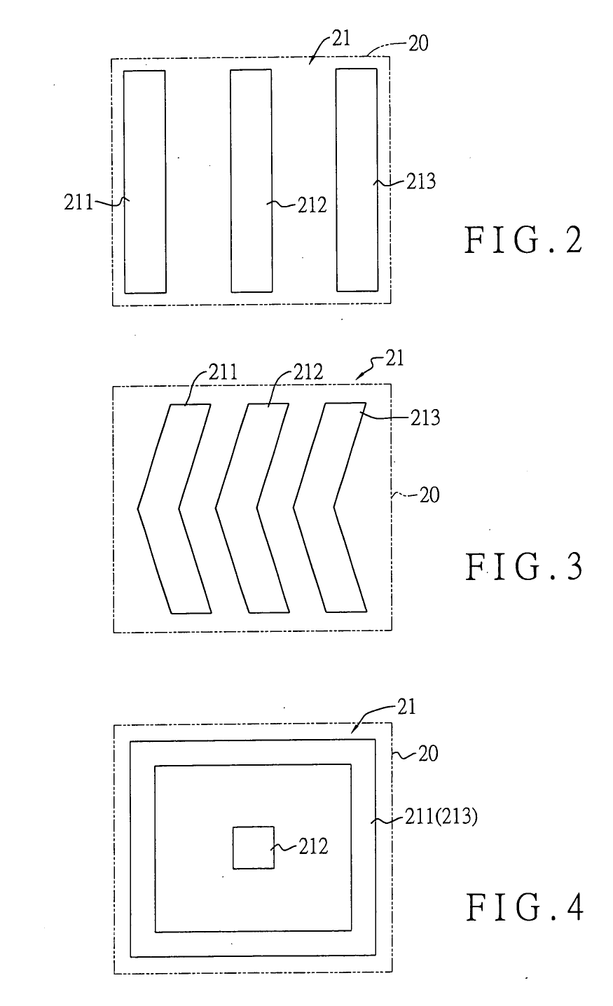

With reference to FIGS. 2 and 3, three second electrode layers (211, 212, 213) of the first embodiment of the EDP are parallel with each other and each second electrode layer (211, 212,213) can be formed as a long narrow strip shape or a substantially <shape. With reference to FIG. 4, one pixel of the second substrate (20) has two second electrode layers (211, 212), one is a rectangular frame and the other is a squire shape in the rectangular frame. The two second electrode layers (211, 212) are period arrangement. These examples are only one part of useful shapes for the second electrode layers.

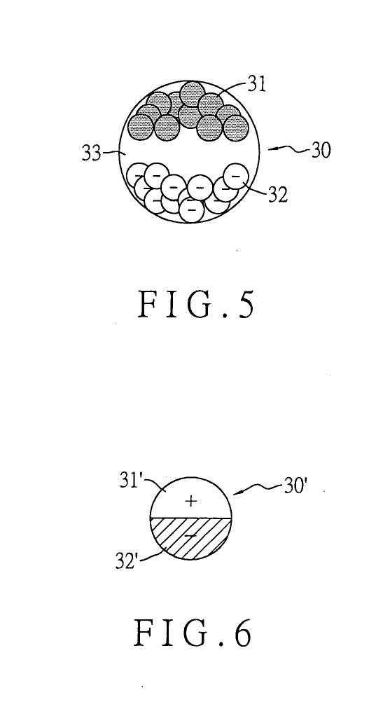

The dark and white colored charged particles (31, 32) filled between the first and second substrates (10, 20) respectively have positive or negative charge. In the first preferred embodiment of FIG. 1, the EPD has positively charged black particles (31) and negatively charged white particles (32) between the first and second substrates (10, 20). With reference to FIG. 5, the EPD also can use microcapsules (30). Each microcapsule (30) has a transparent capsule (not numbered) in which clear fluid (33) and colored charged particles (31, 32) are contained. With reference to FIG. 6, the EPD uses rollers (30′). Each roller (30′) is composed of a white hemisphere (31′) and a dark hemisphere (32′). The whit hemisphere (31′) possess a positive electric charge (+), and the black hemisphere (32′) possess a negative electric charge (−).

The forgoing description discloses a basic structure of the EPD. The following means for driving the EDP is used to the forgoing EPD to make the EPD to have a reflective and/or a direct viewing display mode or a direct viewing display mode.

(1) Reflective Display Mode of the EPD:

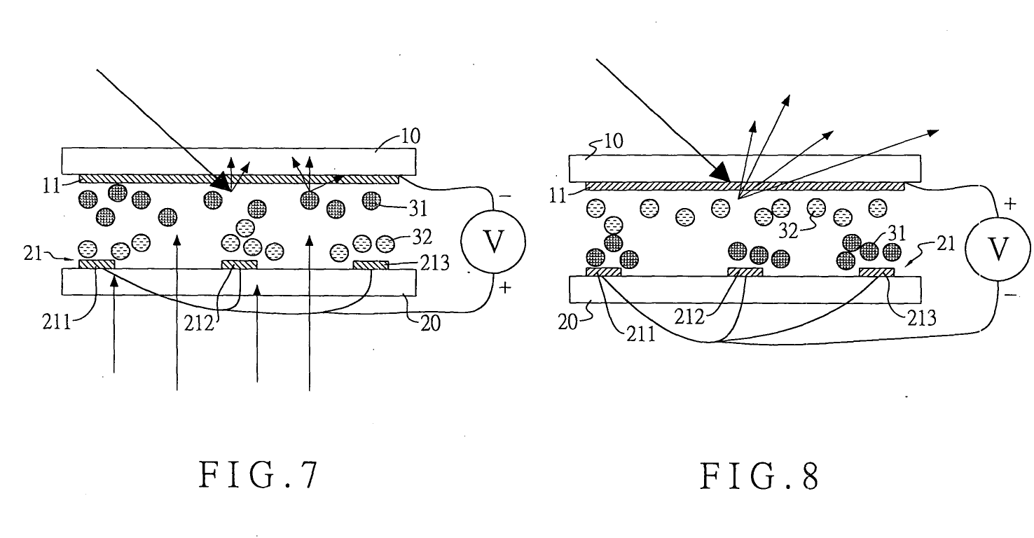

With reference to FIG. 7, a negative potential voltage and a positive potential voltage are respectively applied to the first and second electrode layers (11, 211, 212, 213) of the EDP. The positively charged black particles (31) are moved and collected to the first electrode layer (11) and the negatively charged white particles (32) are moved and collected to the second electrode layers (11, 211, 212, 213). Therefore, the reflective area is established on the first substrate (10) by collecting these positively charged black particles. That is, the front face displays dark spot because the front light is not reflected by the black charged particles and the backlight is blocked not to pass through the first substrate (10).

With reference to FIG. 8, reserving the potentials of voltages applied to the first and second electrode layers (11, 121, 122, 123) causes the negatively charged white particles (32) to be moved and collected to the first electrode layer (11) and the positively charged black particles (32) to be moved and collected to the second electrode layers (211, 212, 213). The front face displays light spot because the front light is reflected by the negatively charged white particles that is collected to the first electrode layer (11).

(2) Direct viewing Display Mode of the EPD:

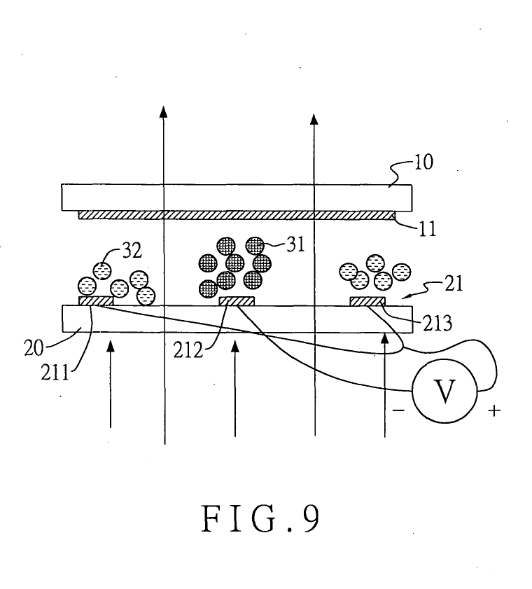

With reference to FIG. 9, the means for driving the EDP is accomplished by applying a negative and a positive potential voltages to the second electrode layers (211, 212, 213). That is, the positive potential voltage is applied to the two second electrode layers (211, 213) and the negative potential voltage is applied to the one second electrode layer (212). All the white and black particles (31, 32) are connected to the three second electrode layers (211, 212, 213). Each transmissive area is defined between two of the second electrode layers (211 to 213) so the backlight can pass through the second and first substrates. The EPD display light spots.

With reference to FIG. 11, a second embodiment of the EPD in accordance with the present invention is similar to the first embodiment. In the second embodiment, a first electrode (11) has three first electrode layers (111 to 113) printed on an inner face (not numbered) of the first substrate (10). Each first electrode layers (111, 122, 113) is aligned with the corresponding second electrode layers (211 to 213). Therefore, one pixel of the EPD has three pairs of first and second electrode layers (111, 211) (112, 212) (113, 213).

The means for driving EPD further uses a positive potential voltage and a negative potential voltage to apply to one pair of the first and second electrode layers (112, 212). With reference to FIG. 12, when the first electrode layer (112) is connected to the positive potential voltage and the second electrode layer (212) is connected to the negative potential voltage, the black and white particles (31, 32) are respectively collected to the pair of the first and second electrode layers (112, 212). The other two pairs of the first and second electrode layers (111, 211) (113, 213) do not collect any particles (31, 32) so more backlight can pass through the second substrate (20) to the first substrate (10). Therefore, the front face (101) is brighter than the first embodiment of the FIG. 10.

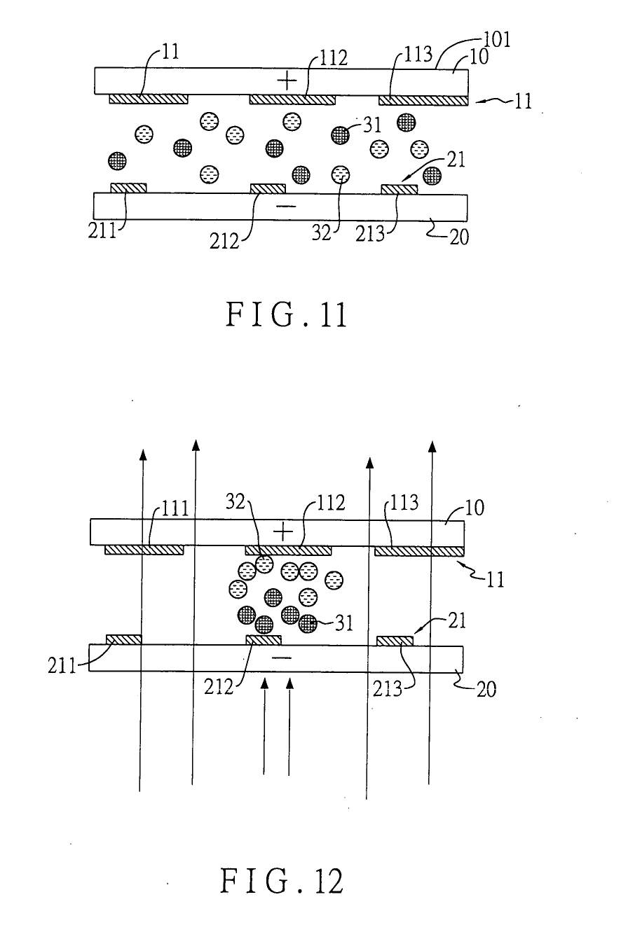

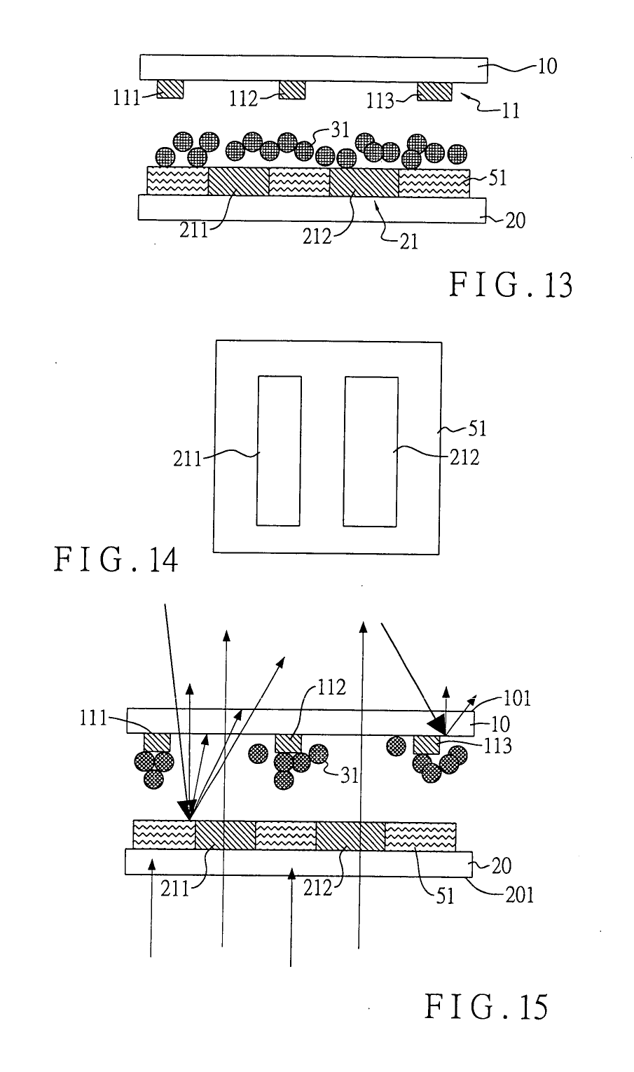

With reference to FIG. 13, a third embodiment of the EPD in accordance with the present invention is similar to the second embodiment of FIG. 11. The third embodiment of the EPD comprises a first substrate (10), a second substrate (20), three first electrode layers (111 to 113) formed on the first substrate (10), two second electrode layers (211, 212) formed on the second substrate (20), a reflective layer (51) formed on the second substrate (20) on which the second electrodes do not formed (as shown in FIG. 14), and multiple single colored (black) charged particles (31).

The two second electrode layers (211, 212) are parallely formed on the second substrate (20). The first electrode layers (111 to 113) are not aligned with the second electrode layers (211, 212). The second electrode layers (211, 212) are transparent so the second electrode layers (211, 212) are defined as transmissive areas of EPD. The reflective layer (51) is made of multiple films with high reflectance.

With reference to FIG. 13, when all black charged particles (31) are collected to the second substrate (20), the backlight can not pass the transmissive areas and the front light is not reflected upward by the black charged particles (31). Therefore, the front face of the EPD displays dark spot.

With reference to FIG. 15, an electric filed is applied to the three first electrode layers (111 to 113) and the black charged particles (31) are collected on the first electrode layers (111 to 113). The front light passes through the first substrate between two of the first electrode layers (111 to 113) and then is reflected upward by the reflective layer (51). In addition, the backlight also passes through the second substrate (20) to the first substrate. Therefore, the front face (101) of the EPD displays bright spots.

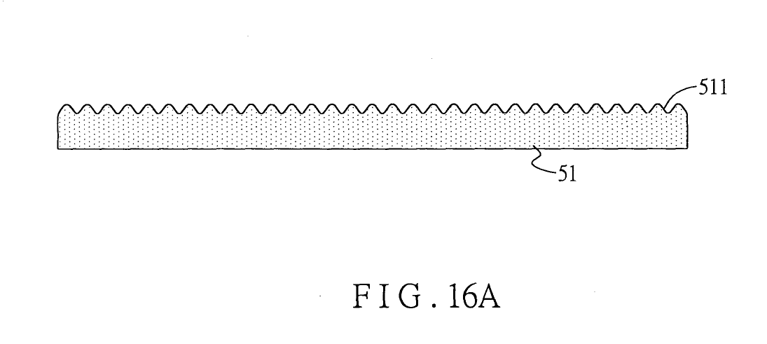

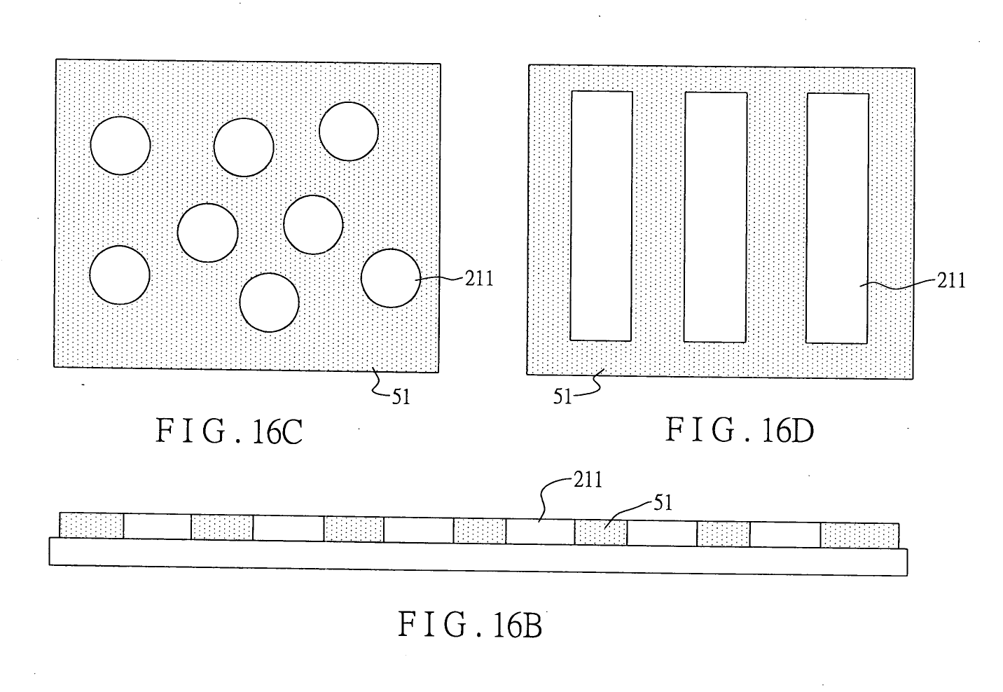

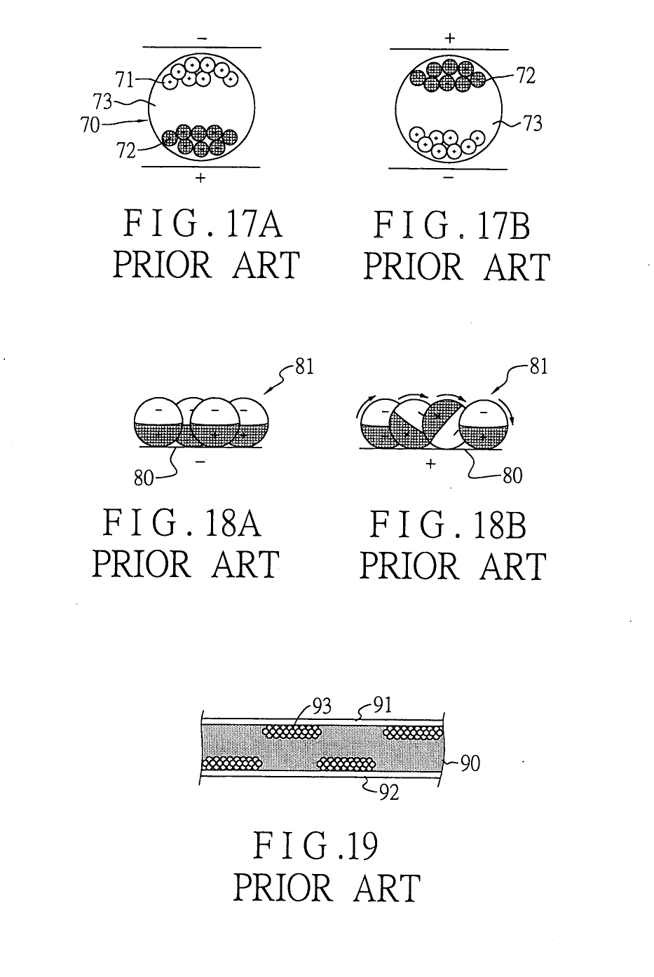

To increase the brightness of the front face (101) the reflective layer (51) has an upper face (511). With reference to FIG. 16A, the upper face (511) can be processed to be diffusive or random wave shaped to provide a scattering capability. The upper face (511) can be a flat as a mirror. With reference to FIG. 16B, the second electrode layers (211) and the reflective layer (51) are alternately formed on the second substrate (not shown). With reference to FIG. 16C, each second electrode layer (211) is circle formed on the second substrate (not shown) and the reflective layer (51) is formed on the second substrate which is not covered by the second electrode layers (211). With reference to FIG. 16D, the three second electrode layers (211) are paralleled to each other on the second substrate and the reflective layer (51) is formed on the second substrate.

Based on the forgoing description, the present invention discloses an EPD having reflective and direct-viewing display modes by selectively controlling a driving means of the EPD. That is, the EPD can become reflective display or a direct-viewing display. When the EPD in sunshine environment, the EPD has enough front light to display so the EDP uses the reflective display mode. On the other hand, when the EPD in light weak environment, the EPD can drive the backlight module to provide a backlight and uses the direct-viewing display mode. Therefore, the present invention can provide high quality of display information or image whether the light is enough or not.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method for driving an electrophoretic display (EPD)that comprises two opposite substrates each distributed with multiple electrodes, fluid between the two substrates, colored charged particles suspended in the fluid and reflective and transmissive areas defined on one of the two substrates or on the two substrates, the method comprising:
applying positive and negative voltages respectively to the electrodes to drive the colored charged particles to the reflective or transmissive areas to control whether front light is reflected by the reflective areas or whether backlight passes through the two substrates.

2. The method as claimed in claim 1, wherein the two opposite substrate are named as a first substrate and a second substrate and each substrate has an inner face and outer face, wherein the electrodes formed on the inner face of the first substrate are first electrodes and the electrodes formed on the inner face of the second substrate are second electrodes, the method further comprising:
adding the positive or negative voltages to the first electrodes to drive the colored charged particles on the first electrodes defined the reflective areas to control whether the front light radiated to the first substrate is reflected by the reflective areas or not.

3. The method as claimed in claim 1, wherein the two opposite substrate are named a first substrate and a second substrates and each substrate has an inner face and outer face, wherein the electrodes formed on the inner face of the first substrate are first electrodes and the electrodes formed on the inner face of the second substrate are second electrodes, comprising:
the transmissive areas defined on the second substrate by the second electrodes, whereby adding the positive or negative electric potential to the second electrodes collects the colored charged particles on the transmissive areas to whether the backlight passes through the transmissive areas.

4. The method as claimed in claim 2, further comprising forming reflective layers each is formed between the two electrodes.

5. The method as claimed in claim 3, further comprising forming reflective layers each is formed between the two electrodes, wherein the reflective layer has an upper face.

6. The method as claimed in claim 5, wherein the upper face is processed as a diffusive or random wave shape to provide a light scattering capability.

7. The method as claimed in claim 1, wherein the colored charged particles are composed of microcapsules each has a transparent capsule, negatively and positively charged colored particles in the transparent capsule and a clear or colored fluid is the transparent capsule.

8. The method as claimed in claim 1, wherein the colored charged particles are composed of rollers each has two colored hemispheres that respectively have a positive electric charge and a negative electric charge.

9. The method as claimed in claim 1 wherein the colored charged particles are single color.

10. An electrophoretic display (EPD), comprising:
two opposite substrates with electrodes;
colored charged particles are between the two opposite substrates; and
reflective and transmissive areas are defined on one of the two opposite substrates or both of them by the electrodes, wherein some of the electrodes are corresponding to the transmissive areas.

11. The EPD as claimed in claim 10, wherein the two opposite substrates are named a first substrate and a second substrates each has an inner face and an outer face, wherein the two inner faces are faced each other and the electrodes formed on the inner face of the first substrate are first electrodes and the electrodes formed on the inner face of the second substrate are second electrodes.

12. The EPD as claimed in claim 11, further comprising reflective layers each is formed between the two of the second electrodes, wherein each reflective layer has an upper face.

13. The EPD as claimed in claim 12, wherein the upper face is processed as a diffusive or random wave shaped to provide a light scattering capability.

14. The EPD as claimed in claim 10 wherein the colored charged particles are composed of microcapsules each has a transparent capsule, negatively and positively charged colored particles in the transparent capsule and a clear or colored fluid is the capsule.

15. The EPD as claimed in claim 10, wherein the colored charged particles are composed of rollers each has two colored hemispheres that respectively have a positive electric charge and a negative electric charge.

16. The EPD as claimed in claim 10, wherein the colored charged particles are single color and have positively charge or negatively charge.

17. The EPD as claimed in claim 11, wherein each first electrode is covered one whole pixel area of the first electrode and each second electrode has at least two second electrode layers.

18. The EPD as claimed in claim 11, wherein each first electrode has at least one first electrode layer and each second electrode is covered one whole pixel area of the second substrate.

19. The EPD as claimed in claim 11, further comprising a backlit module that is mounted on the outer face of the second substrates.

20. The EPD as claimed in claim 11, further comprising a front light module that is mounted on the outer face of the first substrate.

21. The EPD as claimed in claim 11, wherein the first and second substrates are made of the glass, plastic or stainless steel material.

22. The EPD as claimed in claim 11 wherein the first and second electrodes are driven by a static driving circuit.

23. The EPD as claimed in claim 11 wherein the first and second electrodes are driven by an active driving circuit.

24. The EPD as claimed in claim 10, wherein two opposite substrate are named a first substrate and a second substrates each has an inner face and outer face, wherein the all electrodes are formed on the inner face of the first substrate.

25. The EPD as claimed in claim 10, wherein two opposite substrate are named a first substrate and a second substrates each has an inner face and outer face, wherein the all electrodes are formed on the inner face of the second substrate, wherein each electrode comprises an outer electrode layer and an inner electrode layer.

26. The EPD as claimed in claim 25, wherein the outer electrode layer and an inner electrode layer are period arrangement.
